(19) United States
(12) Patent Application Publication
(10) Pub. No.: US 2014/0185773 A1
(43) Pub. Date: Jul. 3, 2014

(54) HUMAN BODY SECURITY INSPECTION SYSTEM

(71) Applicants: TSINGHUA UNIVERSITY, Beijing (CN); NUCTECH COMPANY LIMITED, Beijing (CN)

(72) Inventors: Zhiqiang Chen, Beijing (CN); Yuanjing LI, Beijing (CN); Ziran ZHAO, Beijing (CN); Wanlong WU, Beijing (CN); Le TANG, Beijing (CN); Yinong LIU, Beijing (CN); Yingkang JIN, Beijing (CN); Wenguo LIU, Beijing (CN); Shuo CAO, Beijing (CN); Zhimin ZHENG, Beijing (CN); Guangwei DING, Beijing (CN); Ming RUAN, Beijing (CN); Xiuwei CHEN, Beijing (CN)

(73) Assignees: TSINGHUA UNIVERSITY, Beijing (CN); NUCTECH COMPANY LIMITED, Beijing (CN)

(21) Appl. No.: 14/136,514

(22) Filed: Dec. 20, 2013

(30) Foreign Application Priority Data
Dec. 27, 2012 (CN) 201210580842.X

(51) Int. Cl. G01N 23/203

(52) U.S. Cl. CPC G01N 23/203
USPC 378/87

(57) ABSTRACT

A human body security inspection system including a plurality of ray emitting-detecting modules, which are configured to emit X-rays to the object to be inspected and to receive X-rays scattered from the object to be inspected, wherein the ray emitting-detecting modules form an enclosed region with respect to the object to be inspected and security inspection is implemented on the object in the enclosed region.

This application claims priority from Chinese Patent Application No. 201210580842.X, filed Dec. 27, 2012, which is incorporated herein in its entirety by reference.

### FIELD

The present invention relates to imaging applications, and particularly relates to a back-scattering inspection imaging for the human body.

### BACKGROUND

In a back-scattering inspection imaging application, a ray is modulated and collimated into a pencil beam. The pencil beam scans an object in a point-by-point manner, while a detector receives a ray scattered back from the object, such that a back-scattering image reflecting the information of the object can be obtained where the signals correlates to scanning positions of the human body in a point-to-point way during the data processing.

A known scanning pattern in a prior system is as follows: a pencil beam ray is modulated and collimated in a first dimension direction and the pencil beam ray plane translates together with a detector opposite to a human body along a second dimension direction, wherein the first dimension direction is generally transverse to the second dimension direction.

Typically, there are two ways of scanning in the prior art: one of which is that the pencil beam ray is in the horizontal direction and the pencil beam ray plane translates in a vertical direction and another of which is that the pencil beam ray is in a vertical direction and the pencil beam ray plane translates in a horizontal direction.

### SUMMARY

A disadvantage of the scanning pattern is that only an image of a side of the body closer to the detector can be detected by inspection personnel per scanning, and the other side of the body is a blind area which is unable to be scanned; in order to eliminate the blind area and obtain a complete body image of the human body, the person to be inspected needs to turn 180° after a scan and then be scanned a second time, that is, two scans are required. The turning movement will increase the invalid inspection time and reduce the overall inspection passing rate. For example, a scanning time for single side is typically about 10 seconds, and the total amount of time spent by notifying the person to be inspected by the operator that he/she may turn and time spent by actually turning and re-posing of the person to be inspected is typically 1.5 to 2 seconds. Additionally, 0.5 to 1 seconds or so is required for the operator to recognize that the person to be inspected is re-posed. Such invalid inspection time amounts up to 20-30% of that for the total scanning; more invalid time will be caused if the person to be inspected responds slowly or the communication between the operator and the passenger to be inspected is slow.

Another disadvantage of this scanning pattern is that even if double scanning inspections are performed, since a scanning beam surface and the detector are moved linearly, a surface which is parallel to the scanning beam surface always exists on the human body. Accordingly, a clear and overall scanning cannot be achieved, that is, there is still a small portion of a scanning blind area, such as both sides of the chest, left and right sides of legs and other parts of the human body cannot be scanned.

According to an aspect of the present invention, a human body security inspection system is provided, comprising a plurality of ray emitting-detecting modules, which are configured to emit X-rays to an object to be inspected and to receive X-rays scattered from the object to be inspected, wherein the ray emitting-detecting modules form an enclosed region with respect to the object to be inspected, and security inspection on the object is implemented in the enclosed region.

In an embodiment, the ray emitting-detecting module comprises: a distributed X-ray source, having a plurality of emittance focal spots, each of which provides an X-ray; a collimation plate, having collimation holes which correspond to the emittance focal spots to confine the X-rays emitted from the emittance focal spots into a pencil beam ray; a detector, having through grooves corresponding to the collimation holes, such that the pencil beam ray passes through the through grooves and emits toward the object to be inspected, and the detector receives X rays scattered from the object to be inspected.

In an embodiment, the enclosed region is configured to be one of the following regions: a regular N polygon enclosed region, wherein N is a natural number not less than 4; a circular enclosed region; or an elliptical enclosed region.

In an embodiment, a detachable plurality of ray emitting-detecting modules constituting the enclosed region is connected in a detachable manner.

In an embodiment, the ray emitting-detecting modules are detachably connected in a snap connection manner or at least one of the ray emitting-detecting modules is configured to pivot about a pivot axis.

In an embodiment, the ray emitting-detecting module further comprises a controlling member which controls beam emitting timing of the distributed X-ray source.

The foregoing specific embodiments have at least one or more aspects of the following advantages and effects:

Compared with the prior art, the human security inspection system of an embodiment of the present invention can quickly perform a complete scanning for the human body without a blind area.

### BRIEF DESCRIPTION OF THE DRAWINGS

FIG. 1 is a schematic exploded view of a specific embodiment of the emitting-detecting module according to an embodiment of the invention;

FIG. 2 is a schematic view of an inspection region configured with the emitting-detecting modules according to an embodiment of the present invention; and

FIG. 3 is a schematic view of a human body security inspection system according to an embodiment of the present invention.

### DETAILED DESCRIPTION OF THE EMBODIMENTS

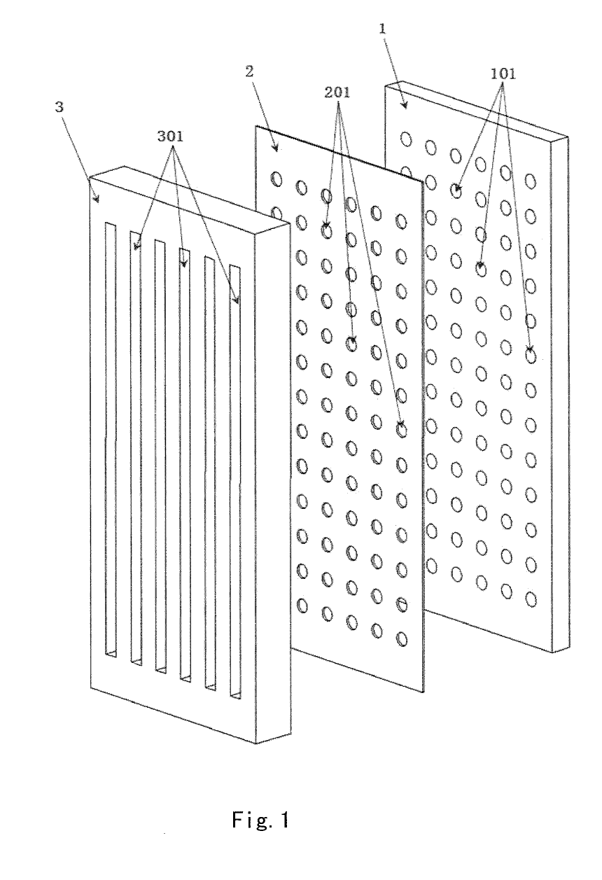

Next, through the following embodiments combined with accompanying FIGS. 1-3, the technical solution of an embodiment of the present invention is further specifically described. In the specification, the same or similar reference numerals indicate the same or similar components. The description below with reference to the accompanying drawings illustrates an embodiment of the present invention and is intended to explain the general inventive concept without being construed as a limitation of the invention.

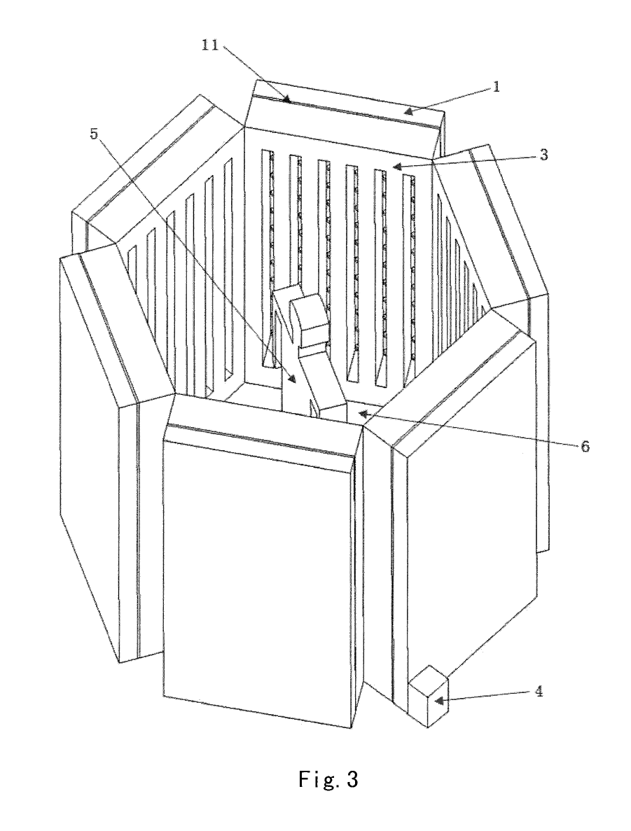

A human body security inspection system according to an embodiment of the present invention, shown in FIG. 3, comprises a plurality of ray emitting-detecting modules (EDM) 11, which are configured to emit X-rays to an object 5 to be inspected and to receive X-rays scattered from the object 5 to be inspected, wherein the ray emitting-detecting modules 11 form an enclosed region with respect to the object 5 to be inspected, such that security inspection is performed in the enclosed region.

As shown in FIG. 1, according to an embodiment of the present invention, a ray emitting-detecting module 11 comprises: a distributed X-ray source 1, having a plurality of emittance focal spots 101, each of which provides an X-ray; a collimation plate 2, having collimation holes 201 corresponding to the emittance focal spots 101 to confine the X-rays emitted from the emittance focal spots 101 into a pencil beam ray; and a detector 3, having through grooves 301 corresponding to the collimation holes, such that the pencil beam ray passes through the through grooves and emits toward the object 5 to be inspected, and the detector 3 receives X rays scattered from the object 5 to be inspected.

According to an embodiment of the present invention, the number of the emittance focal spot 101 depends on resolution and other characteristics as required, and the present invention is not limited by this embodiment. The number shown in the accompanying drawings is used only as an example and the present invention is not limited by this embodiment. As shown in FIG. 1, a plurality of focal spots 101 is arranged in two dimensions. Each focal spot can emit a ray separately, and in an embodiment, it can be controlled by an external control signal controller based on a predetermined sequence.

According to an embodiment of the present invention, the collimation plate 2 is made of a material shielding of the X-ray, such as lead, tungsten, copper, steel, lead oxide, tungsten oxide, etc., or a mixture of any of the above types of materials, desirably lead. Collimation holes 201 corresponding to a position of the emittance focal spots 101 of a X-ray source 1 is provided on the collimation plate 2, such that the rays emitted from the emittance focal spots 101 are confined into a pencil beam ray. The collimator holes 201 may be circular, square, and desirably circular.

The detector 3 may absorb X-rays and convert it into electrical signals, and the electrical signals are further converted into a digital signal which can be displayed by means of a computer. The detector 3 comprises through grooves 301 corresponding to the collimation holes 201, such that the pencil beam ray passes through the through grooves 201 and emits toward the human body.

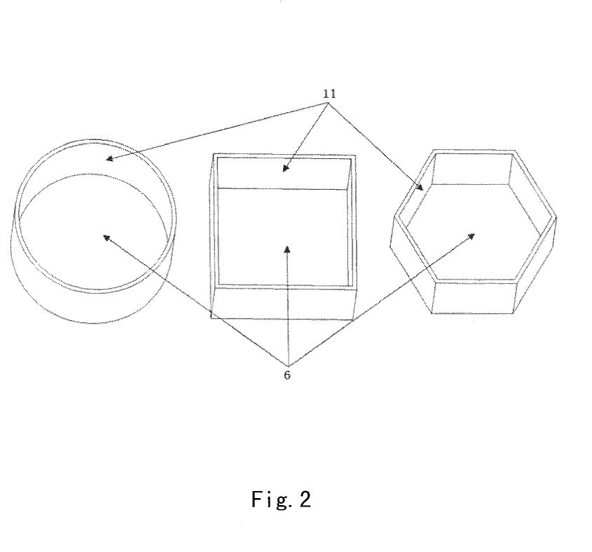

An “emitting-detecting” module (referred to as EDM) 11 is composed of a distributed X-ray source 1, a collimation plate 2 and a detector 3. A plurality of EDMs may form an inspection region 6, the number of which can be determined according to operational requirements. As shown in FIG. 2, the inspection region 6 may be a square enclosed by four EDMs 11, or a regular N polygon enclosed by Nth EDMs 11 (N can be any natural number greater than or equal to 4), or a circular or elliptical inspection region may be formed by one or more of arc EDMs 11, all of which are within the scope of this invention. In an embodiment, a hexagon inspection region is enclosed by six EDMs 11.

According to an embodiment of the invention, as shown in FIG. 3, a detachable connector is provided among the plurality of ray emitting-detecting modules constituting the enclosed region.

In an embodiment, the detachable connector is configured to be a snap connection or at least one of the plurality of ray emitting-detecting modules is configured to pivot about a pivot axis.

For example, by way of the detachable connector, the position of one or several EDMs can be conveniently changed. When a pivot axis is adopted, a pivot connection between the EDMs can be designed to have a structure like a door shaft. To be more specific, one of the EDMs can be controlled by a driven motor to implement an operation such as pivoting of a door. This makes it convenient for the person to be inspected to access an inspection region.

In an embodiment of the present invention, a controlling member 4 is provided which controls beam emitting timing of the distributed X-ray source. For example, it can be controlled to emit a beam only from one focal spot at one time such that a flying spot scanning as required is formed. The beam may be sequentially emitted from the source in a vertical direction or a horizontal direction, desirably in a vertical direction.

A human body security inspection system according to an embodiment of the present invention performs security inspection as follows:

A person 5 to be inspected enters an inspection region 6 and stands still. A controlling member 4 controls one column of focal spots of the X-ray source 1 of the EDM 11 to emit a beam in sequence in a vertical direction, so as to achieve one column of uniform scanning for the person to be inspected in the vertical direction.

After one column is scanned, the controlling member 4 controls an adjacent next one column of focal spots of the X-ray source 1 of the EDM 11 to emit a beam in sequence in the vertical direction, so as to achieve a second column of uniform scanning for the person to be inspected in the vertical direction. Similarly, the controlling member 4 controls other columns of focal spots of the X-ray source 1 of the EDM 11 to implement scanning by sequentially emitting beams point by point.

Similarly, the controlling member 4 controls all columns of focal spots of other EDMs 11 to emit beams in sequence. While the beams are emitted, the controlling member 4 controls the detector 3 to perform signal acquisition in accordance with the corresponding frequency based on the timing frequency which controls the emitting beam of the X-ray source. When all focal spots of the X-ray source 1 of all EDMs 11 have completed emittance of beams point-by-point, the scanning over all the human body is finished and the person 5 to be inspected leaves the inspection region 6 without turning around or changing his or her posture.

An embodiment of the invention provides a human body security inspection system that uses a non-linear scanning path around the body, therefore, the common scanning blind area, such as both sides of the body, arms, legs, etc., can be completely eliminated. With a two-dimensional distribution of a distributed X-ray source focal spot, a switching focal spot can be realized by only adding a certain timing control signal, which not only replaces mechanical motion in a first dimension direction with a traditional flying spot scanning, but also replaces a scanning motion in a second dimension. Therefore a fully fixed structure is used, during a scanning process, no moving parts are required, which greatly simplifies the mechanical structure and a satisfactory scanning speed can be achieved. Further, during the scanning process, a person to be inspected does not turn around and change his posture, which can minimize the invalid time of the entire inspection and/or improve the passing rate of person to be inspected. Moreover, a passenger's feelings of being controlled caused by changing his or her posture can also be greatly improved, reducing the person's psychological discomfort and resentment.

Although some embodiments of general inventive concept of the present have been shown and described, those having ordinary skill will understand that the present invention can make changes to these embodiments without departing from the spirit and the principles in the general concept of the present invention, the scope of the present invention is defined by the claims and their equivalents.

What is claimed is:

1. A human body security inspection system comprising a plurality of ray emitting-detecting modules, which are configured to emit X-rays to an object to be inspected and to receive X-rays scattered from the object to be inspected, wherein the ray emitting-detecting modules form an enclosed region with respect to the object to be inspected and security inspection on the object is implemented in the enclosed region.

2. The human body security inspection system according to claim 1, wherein the ray emitting-detecting module comprises:
a distributed X-ray source, having a plurality of emittance focal spots, each of which provides an X-ray;
a collimation plate, having collimation holes corresponding to the emittance focal spots to confine the X-rays emitted from the emittance focal spots into a pencil beam ray; and
a detector, having through grooves which correspond to the collimation holes, such that the pencil beam ray passes through the through grooves and emits toward the object to be inspected, and the detector receives X rays scattered from the object to be inspected.

3. The human body security inspection system according to claim 1, wherein the enclosed region is selected from one of the following:
a regular N polygon enclosed region, wherein N is a natural number not less than 4;
a circular enclosed region; or
an elliptical enclosed region.

4. The human body security inspection system according to claim 1, wherein the plurality of ray emitting-detecting modules constituting the enclosed regions is connected by a detachable connector.

5. The human body security inspection system according to claim 4, wherein the detachable connector is configured to be a snap connection or at least one of the plurality of ray emitting-detecting modules is configured to pivot about a pivot axis.

6. The human body security inspection system according to claim 2, further comprising a controlling member which controls a beam emitting timing of the distributed X-ray source.
